(19) United States
(12) Patent Application Publication
(10) Pub. No.: US 2019/0087711 A1
(43) Pub. Date: Mar. 21, 2019

(54) INTELLIGENT, ADAPTIVE CONTROL SYSTEM AND RELATED METHODS FOR INTEGRATED PROCESSING OF BIOMASS

(71) Applicants: Battelle Energy Alliance, LLC, Idaho Falls, ID (US); Virginia Commonwealth University, Richmond, VA (US)

(72) Inventors: Kevin L. Kenney, Idaho Falls, ID (US); Matthew O. Anderson, Idaho Falls, ID (US); David P. Pace, Idaho Falls, ID (US); Neal A. Yancey, Firth, ID (US); Milos Manic, Henrico, VA (US); Kasun Amarasinghe, Richmond, VA (US); Daniel Leonardo Marino, Richmond, VA (US)

(21) Appl. No.: 16/131,967

(22) Filed: Sep. 14, 2018

Related U.S. Application Data
(60) Provisional application No. 62/559,183, filed on Sep. 15, 2017.

(51) Int. Cl. G06N 3/04; G06N 5/00; G05B 19/4155

(52) U.S. Cl. CPC G06N 3/0436; G05B 2219/37255; G05B 19/4155; G06N 5/003

(57) ABSTRACT

Adaptive control systems and methods of using the same to control aspects of material processing systems are described. The adaptive control systems may incorporate techniques that use heuristic modeling, and apply those techniques to control processing of biomass feedstock.

### PRIORITY CLAIM

This application claims the benefit of the filing date of U.S. Provisional Patent Application Ser. No. 62/559,183, filed Sep. 15, 2017, for “Intelligent, Adaptive Control System and Related Methods for Integrated Processing of Biomass.”

### STATEMENT REGARDING FEDERALLY SPONSORED RESEARCH OR DEVELOPMENT

This invention was made with government support under Contract Number DE-AC07-051D14517 awarded by the United States Department of Energy. The government has certain rights in the invention.

### TECHNICAL FIELD

Various embodiments described in this disclosure relate to adaptive control systems and methods of using the same. Some embodiments more specifically relate to techniques for heuristic modeling, and applying those techniques to control pre-processing of biomass feedstock.

### BACKGROUND

Biomass processing systems mechanically deconstruct bulk biomass (e.g., bales of biomass) into bulk solids that can be conveyed, pumped, and fed into a reactor where they are converted to bioproducts. Mechanical deconstruction is typically accomplished with hammermill grinders and/or shredders. Feed handling problems arise from the inability of conventional front-end bale processing systems to reliably operate, for example, experiencing greater than expected performance variability. Studies have shown that conventional production plants that process raw bulk solid (i.e. particulate) materials may operate at less than 50% of their design capacity during their first year of operation. In contrast, conventional production plants that handle liquids and gases typically operated close to 90% of their design capacity.

Accordingly, there are drawbacks and deficiencies with existing biomass processing systems.

### BRIEF SUMMARY

Various embodiments of the disclosure relate, generally, to a control system. The control system may include a first controller and a second controller. The first controller may be operable to monitor and control an infeed processing system. The second controller may be operable to generate supervisory command and estimate one or more performance conditions of the controller process of the infeed processing system. The supervisory commands may be configured to effectuate a change by the instrumentation controller in the infeed processing system. The one or more estimates may be generated responsive to a predictive model, an infeed condition measurement, and an operational measurement. The infeed condition measurement may be indicative of a condition of infeed material undergoing the controlled process of the infeed processing system. The operational measurement may be indicative of an operation of the infeed processing system during the controlled process.

Other embodiments of the disclosure relate, generally, to a process controller. The process controller may include a data management module, a prediction module, and an intelligence module. The data management module may be configured to receive one or more measurements indicative of a controlled process of an infeed processing system. The prediction module may be configured to generate estimates of the performance of the controlled process responsive to a predictive model and the one or more measurements indicative of the controlled process. The intelligence module may be configured to generate process condition adjustments responsive to an intelligence model and the one or more measurements indicative of the controlled process.

Other embodiments of the disclosure relate, generally, to a method of controlling a process. The method may include generating one or more performance estimates of the process responsive to a first heuristic model and at least one measurement indicative of the controlled process; generating one or more process condition adjustments responsive to a second heuristic model, at least one upset condition, and the at least one measurement; and generating a command responsive to the one or more process condition adjustments, the command comprising one or more parameters to effectuate change in the process.

### BRIEF DESCRIPTION OF THE DRAWINGS

The patent or application file contains at least one drawing in color. Copies of this patent or patent application publication with color drawings will be provided by the Office upon request and payment of necessary fees.

Purposes and advantages of the embodiments of the disclosure will be apparent to one of ordinary skill in the art from the detailed description in conjunction with the appended drawings, including:

FIG. 1 shows a block diagram of intelligent control logic in accordance with an embodiment of the disclosure;

FIG. 2 shows a block diagram of an intelligent controller, in accordance with an embodiment of the disclosure;

FIG. 3 shows a block diagram of an adaptive control system 1 that is integratable to an infeed processing system, in accordance with an embodiment of the disclosure;

FIG. 4 shows a block diagram of a biomass processing system, in accordance with an embodiment of the disclosure;

FIG. 5 shows a block diagram of an infeed processing system with integrated adaptive control system, in accordance with an embodiment of the disclosure;

FIG. 6 is a cross-functional flowchart showing an operation of an infeed processing system with an integrated adaptive control system, in accordance with an embodiment of the disclosure;

FIG. 7 is a diagram of an operation of an infeed processing system with an integrated adaptive control system, in accordance with an embodiment of the disclosure;

FIG. 8 is a cross-functional flowchart showing an operation of an adaptive control system, in accordance with an embodiment of the disclosure;

FIG. 9 is a cross-functional flowchart showing an operation of an adaptive control system, in accordance with an embodiment of the disclosure;

FIG. 10 is a cross-functional flowchart showing an operation of an infeed processing system with an integrated adaptive control system, in accordance with an embodiment of the disclosure;

FIG. 11 is a cross-functional flowchart showing an operation of an infeed processing system with an integrated adaptive control system, in accordance with an embodiment of the disclosure;

FIG. 12 illustrates a dashboard that interfaces with an intelligent controller, in accordance with an embodiment of the disclosure.

### DETAILED DESCRIPTION

The following description provides specific details to provide a thorough description of various embodiments of the invention. However, one of ordinary skill in the art will understand that the disclosed embodiments may be practiced without using these specific details. Indeed, the disclosed embodiments may be practiced in conjunction with conventional systems and methods used in the industry. In addition, only those elements helpful to understand and enable one of ordinary skill in the art to practice the disclosed embodiments are described in detail. One of ordinary skill in the art will recognize that some elements not described herein but, using various conventional method components and acts, would be in accord with the embodiments of this disclosure.

The following description may include examples to help enable one of ordinary skill in the art to practice the disclosed embodiments. The use of the terms “exemplary,” “by example,” and “for example,” means that the related description is explanatory and though the scope of the disclosure is intended to encompass the recited examples and legal equivalents, the use of such terms is not intended to limit the scope of an embodiment or this disclosure to the specified components, steps, features, functions, arrangement of components, or the like. Moreover, the use of such terms does not indicate or imply that the related description comprises or is a preferred embodiment.

Any drawings accompanying this disclosure are for illustrative purposes only and are not drawn to scale. Elements common among figures may retain the same numerical designation; however, the similarity in numbering does not mean that the structures or components are necessarily identical in size, composition, configuration, or any other property.

It will be readily understood that the components of the embodiments as generally described herein and illustrated in the drawing could be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are by way of example only and should not be construed as the only way to implement the present disclosure unless specified otherwise herein. Additionally, block definitions and partitioning of logic between various blocks is/are examples of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Many of the functional units described in this specification may be illustrated, described or labeled as logic, modules, engines, threads, or other segregations of programming code, to more particularly emphasize their implementation independence in accomplishing the features, functions, tasks or steps that are generally described herein. The various illustrative logical blocks, modules, and circuits described in connection with the embodiments disclosed herein may be at least partially implemented or performed with a general purpose processor, a special purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein.

The functional units may be implemented using software or firmware, stored on a computer-readable storage medium, in system memory, or a combination thereof for execution by various types of processors.

In the case of a general-purpose computer, these logic and modules may be embodied in software classes and applications executed by processor cores, and while the modules are executing the general purpose computer may be thought of as a special purpose computer or a specific purpose computer. The logic and modules may also relate to specific purpose hardware, including the firmware and machine code, controlling its operation. An identified module of executable code may, for instance, comprise one or more physical or logical blocks of computer instructions, which may, for instance, be organized as a thread, object, procedure, or function. Nevertheless, the executable code of an identified module need not be physically located together, but may comprise disparate instructions stored in different locations which, when joined logically together, comprise the module and achieve the stated purpose for the module.

A module of executable code may comprise a single instruction, or many instructions, and may even be distributed over several different code segments, among different programs, and across several storage or memory devices. Similarly, operational data may be identified and illustrated herein within modules, and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the software portions are stored on one or more physical devices, which are referred to herein as computer-readable media.

In some embodiments, the software portions are stored in a non-transitory state such that the software portions or representations thereof, persist in the same physical location for a period of time. Additionally, in some embodiments, the software portions are stored on one or more non-transitory storage mediums, which include hardware elements capable of storing non-transitory states and/or signals representative of the software portions, even though other portions of the non-transitory storage mediums may be capable of altering and/or transmitting the signals. Examples of non-transitory storage mediums are flash memory and random-access memory (RAM). Another example of a non-transitory storage medium includes a read-only memory (ROM) which can store signals and/or states representative of the software portions for a period of time. However, the ability to store the signals and/or states is not diminished by further functionality of transmitting signals that are the same as, or representative of, the stored signals and/or states. For example, a processor may access the ROM to obtain signals that are representative of the stored signals and/or states to execute the corresponding software instructions.

A general-purpose processor (which may also be characterized herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer when the general-purpose computer is configured to execute computing instructions (e.g., software code) related to embodiments of the present disclosure.

The embodiments disclosed herein may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be rearranged. A process may correspond to a method, a thread, a function, a procedure, a subroutine, a subprogram, etc. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Various embodiments described herein may include elements described as implemented in a “workstation,” “computer,” or a “computer system.” Here, the terms “workstation,” “computer,” and “computer system” are to be understood to include at least one non-transitory computer-readable medium and at least one processing unit. In general, the storage medium will store, at one time or another, at least portions of an executable program code, and the processor(s) will execute one or more of the instructions included in that executable program code. It will be appreciated that the term “executable program code” and the term “software” mean substantially the same thing for the purposes of this description. It is not necessary to the practice of the various embodiments described herein that the storage medium and the processing unit be physically located in the same place. That is to say, it is foreseen that the processor and the memory might be distributed among physical pieces of equipment or even in geographically distinct locations. One of ordinary skill in the art will appreciate that “media,” “medium,” “storage medium,” “computer-readable media,” or “computer-readable medium” as used here, may include a diskette, a magnetic tape, a digital tape, a compact disc, an integrated circuit, a ROM, a CD, DVD, Blu-Ray, a cartridge, flash memory, PROM, a RAM, a memory stick or card, or any other non-destructive storage medium useable by computers, including those that are re-writable.

Although the enabling software might be “written on” a disc, “embodied in” an integrated circuit, “carried over” a communications circuit, “stored in” a memory chip, or “loaded in” a cache memory, it will be appreciated that, for the purposes of this disclosure, the software will be referred to simply as being “in” or “on” a main memory that is a computer-readable medium. Thus, the terms “in” or “on” are intended to encompass the above mentioned and all equivalent and possible ways in which software can be associated with a computer-readable medium.

Users may interact with the computer systems described herein by way of graphical user interfaces (GUIs) on a display and input devices such as touchscreens, keyboards, a computer mouse, touchpads, buttons, switches, jumpers, and the like. A GUI may include a console and/or dashboard and a user may interact with the GUI and, in turn, underlying software applications.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes, to a degree, that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

It is now understood by the inventors of this disclosure that the biomass quality attributes of moisture, ash, and particle size distribution are correlated to infeed processing performance. Dry infeed material deconstructs differently than wet infeed material. As moisture content increases, the infeed material often becomes tougher and is harder to deconstruct. Further, because dry and wet infeed materials deconstruct differently, the resulting processed particle sizes differ, which may cause problems with downstream handling, feeding, and conversion.

Infeed process equipment known to the inventors of this disclosure does not adapt parameters for operational process conditions to variable infeed conditions. Typically, process conditions are fixed based on an actual or assumed set of specific (or minimally variable) infeed conditions. Known control systems for infeed processing applications (e.g., processing grain at a starch ethanol plant) are limited, utilizing feedback (interlock) control logic to shut the system down should an upset condition occur such as material plugging in equipment.

As used herein, “biomass” means any organic material. Examples of sources of biomass include wood-based, agricultural, and waste/byproducts. Examples of wood-based biomass are pulp wood, saw timber, forestry residues (branches, tree tops, clearing material), and mill residues. Examples of agricultural biomass are corn, sugar, potatoes, straw, grains, grass, algae, and residues thereof (stems, leaves, etc.). Examples of waste/byproducts are human and animal waste, animal process residue, water treatment sludge, refuse derived fuel, and food waste.

As used herein, “feedstock” means the organic material that is converted to fuel, for example, by fermentation, esterification, or transesterification. Feedstock may be unprocessed biomass or processed biomass.

As used herein, “infeed” and “infeed material” means the biomass that is input to a biomass processing system to form feedstock. Infeed for processing may be packaged in bales formed by compressing biomass into bundles, or may be in a loose, bulk format. A bale may consist of one type of biomass or a variety of biomass types, further, the condition of the biomass may vary within a bale. Bales may be arranged with other bales having similar dimensions and weight, though dimensions and weight may vary along with the condition of the baled biomass.

Various embodiments described herein relate, generally, to adaptive control systems that may be integrated with biomass processing systems to monitor system performance and the condition of the infeed material, and may affect in-situ adjustments to processing equipment parameters. Embodiments may incorporate heuristic models built from historical data. Known control systems that implement system intelligence typically use process models (which are timely and expensive to develop) or forego models and employ defensive control system logic via limit-switches.

Historical data provides a tool for analyzing and obtaining mathematical models that estimate the performance (e.g., throughput, energy consumption, quality, etc.) of a biomass processing system for given operational conditions and infeed conditions. As used herein, “process condition(s)” means an equipment process condition relevant to a process under control, for example, infeed rate, residence time, etc. As used herein, “operational condition(s)” means a parameter for a condition of equipment or chemicals used in biomass processing, for example, motor speed (conveyor or grinder), grinder screen size, amount of chemical, heat time, heat temperature, etc. As used herein, “material condition(s)” means a parameter for a condition of a material used in biomass processing, such as an infeed material. Infeed moisture content, infeed moisture content variability, infeed weight, particle size, particle size variability, ash content etc., are examples of material conditions.

As used herein, “historical data” means material conditions (e.g., of infeed), operational conditions, process conditions, and performance measurements obtained from “typical” or representative systems like those intended to be controlled.

In one or more embodiments, Gaussian processes (GP) may be used to obtain a heuristic model of an optimization parameter as a function of operational conditions of the process equipment and condition of the infeed material. For example, throughput and/or reliability of a biomass processing system may be modeled as a function of the infeed rate, infeed moisture content, current to motor (a measure of conveyance speed or how hard the equipment is working), and grinder screen size. One or more embodiments may incorporate uncertainty in the modeled optimization parameters. Techniques for using Gaussian processes to obtain models using training datasets and testing datasets are generally known to those of ordinary skill in the art.

In one or more embodiments, a linear mean function (x) or a zero mean for the historical data may be incorporated with a Gaussian process. Using a linear mean function (x) provides accurate predictions in non-explored spaces, based on the trend of data. In the Bayesian setting, the distribution in the historical data may be used to introduce assumptions for a model before taking into consideration sampled data. A linear mean function (x) extracted from historical data may provide a high bias model that improves estimates when extrapolating, while the Gaussian processes provide local expressive models for modeling local non-linear behavior. In one embodiment, instead of a typical L₂ linear regression, robust linear regression may be used for extracting (x). Robust linear regression may reduce corruption of the data from noise that is not normally distributed throughout the historical data.

Other machine learning techniques, including those that incorporate Bayesian learning concepts are specifically contemplated and may be used to heuristically model historical datasets.

In various embodiments, historical data may be combined with real-time (e.g., sampled data) data about a biomass processing system to identify adjustments to process conditions that may improve performance of the biomass processing system (e.g., maximize system performance). In one or more embodiments, one or more Fuzzy Logic (FL) algorithms may be used to model operator knowledge related to operational conditions, infeed conditions, and adjustments to processing conditions. For example, an operator may set a “low” infeed rate (e.g., a processing condition) if the moisture content is “high” (e.g., an infeed condition). The boundary between “low,” “medium,” and “high” moisture content is made in the operators “expert” opinion. The FL algorithms may use fuzzy membership sets to describe the moisture content as “low,” “medium,” and “high.” Fuzzy rules are defined for the specific fuzzy sets. What follows is an example of linguistic terms:

IF moisture is “low” THEN infeed rate is 13% of maximum

IF moisture is “medium” THEN infeed is 10% of maximum

IF moisture is “high” THEN infeed is 6% of maximum

By way of an operational example, a measured moisture content of infeed is mapped to each fuzzy set using a “degree of belonging”—e.g., 10% moisture content would have a high “degree of belonging” to the “low” fuzzy set, and have a very low “degree of belonging” to the “high” fuzzy set. The output is a fuzzy membership function defined by the fuzzy sets and the “degree of belonging.” The fuzzy rules are applied to the fuzzy membership function to realize a fuzzy inference. A value for the infeed rate is determined that best “fits” the fuzzy inference. Various algorithms may be used to determine the best fit, for example, center of area/gravity, fuzzy mean, fuzzy clustering defuzzification, or weighted fuzzy mean.

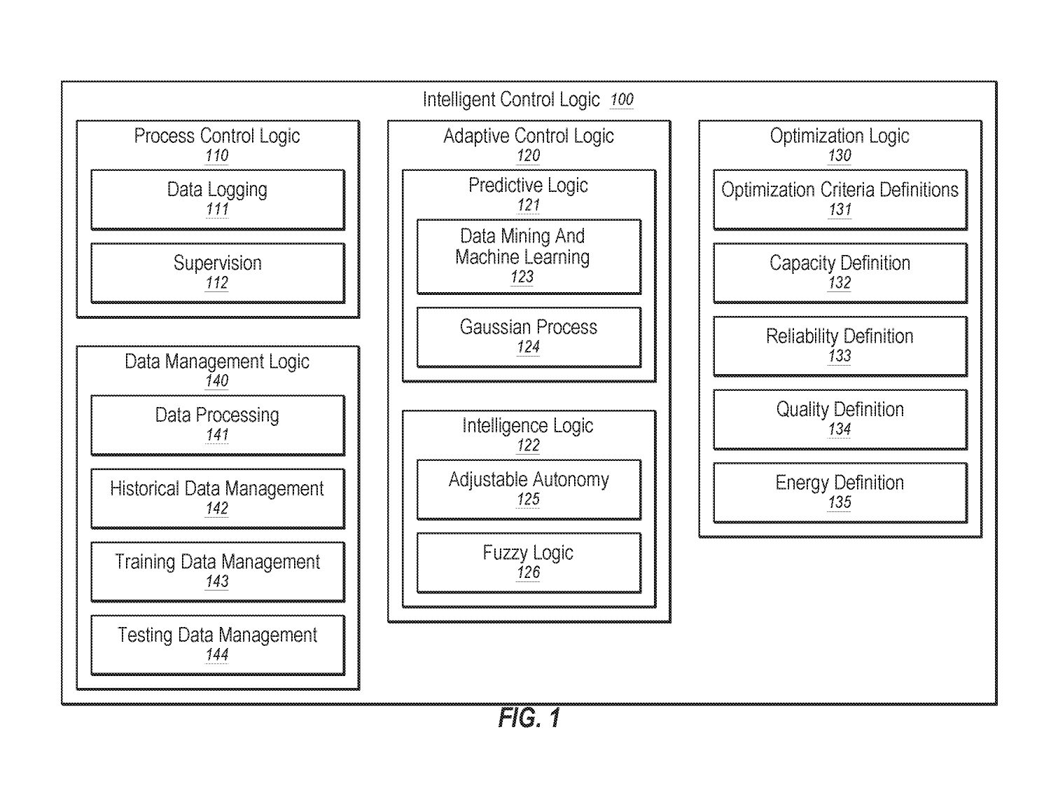

FIG. 1 illustrates intelligent control logic 100, in accordance with an embodiment of the disclosure. The intelligent control logic 100 may include process control logic 110, adaptive control logic 120, optimization logic 130, and data management logic 140. Instances of the intelligent control logic 100 and the various logical components associated with it may be referred to herein as “modules” when in operation.

The process control logic 110 may include the logic that defines the various processes that may be under control of intelligent control logic 100. In various embodiments, the process control logic 110 may include definitions of the various processing equipment conditions that are under the control of the intelligent control logic 100 and the definitions for providing supervisory commands to the equipment that may affect a process under control. In one embodiment, the process control logic 110 may include one or more functions to enable, for example, data logging 111 and supervision 112. In various embodiments, the data logging 111 may include receiving, sorting, and storing measurements of a biomass processing system, for example, measurements of the operation of the biomass processing system and measurements of the infeed material. Measurements of the biomass processing system may include measurements of the processing equipment (e.g., conveyors, grinders, meters, etc.) and metrics determined responsive to such measurements.

In various embodiments, the supervision 112 may include the logic for providing supervisory commands to affect a biomass processing system change, for example, responsive to operator commands.

The adaptive control logic 120 may include predictive logic 121 and intelligence logic 122. Embodiments of the adaptive control logic 120 may include algorithms to heuristically model aspects of a biomass processing system, estimate the performance of a biomass processing system, and identify adjustments to process conditions of the biomass processing system. Embodiments of the adaptive control logic 120 may also include algorithms to update and improve historical data sets as well as update the various heuristic models of the adaptive control logic 120. The predictive logic 121 may include one or more functions to enable building and updating various predictive models, for example, data mining and machine learning 123, and Gaussian process 124.

In some embodiments, adaptive logic 120 may incorporate process models with the heuristic models. For example, process models may be used to check the results of a heuristic model, generate training datasets, etc.

The data mining and machine learning 123 may include one or more algorithms for conditioning data and analyzing data to identify and discover properties of the data. Data mining and machine learning 123 may include analytical algorithms, for example, linear regression, random forest, or k-means clustering to iteratively “learn” about historical data. Data sets analyzed by the data mining and machine learning 123 may be “raw” data, in contrast to the training datasets and testing datasets used in Gaussian process 124.

The intelligence logic 122 may include one or more functions to enable building and updating intelligent models, for example, fuzzy logic 126 and adjustable autonomy 125.

The optimization logic 130 may include optimization criteria definitions 131. Generally, optimization criteria definitions define one or more performance metrics related to a biomass processing system. In various embodiments, optimization criteria may be parameterized and modeled as function of, for example, process equipment and infeed condition.

In various embodiments, optimization criteria definitions 131 may include one or more of capacity definitions 132, reliability definitions 133, quality definitions 134, and energy definitions 135. An example of a capacity definition 132 is the mass or volumetric flow rate through a biomass processing system as a function of time (e.g., tons per hour). Throughput may also be modeled in efficiency terms, for example, the ratio of the rated/actual throughput of a piece of equipment in terms of the full load amperage rating of the motor. An example of a reliability definition 133 is the amount of time that a biomass process system is functioning over a defined time period, and may be measured in terms of uptime or downtime. An example of a quality definition 134 is the variability in processed material that is the output of the biomass processing system. The variability may be in terms of a desired condition of the processed infeed (e.g., average size of the output processed material), and may also be in terms of the variability of the condition of the infeed material—e.g., variability of the size of the output processed material compared to the desired condition. An example of an energy definition 135 may be the total electricity consumption summed over all equipment that comprises a process system over a defined time period—e.g., the amount of electricity of a grinder or conveyor over a defined time period or event.

The optimization criteria definitions 131 are described, above, at a system level, but they are not so limited, and may be defined at a process level, sub-process level, and/or a component level.

The data management logic 140 may include algorithms for managing one or more of historical data, training data, and test data. In various embodiments, the data management logic 140 may include one or more functions to enable data processing 141, historical data management 142, training data management 143, and testing data management 144. Data processing 141 may include conditioning datasets as well as new data. Historical data management 142 may include parsing, sorting, updating, and merging datasets to form one or more historical datasets. Updating may include inserting new data into existing historical datasets, as well as removing data from existing historical datasets. Training data management 143 and testing data management 144 may include generating, parsing, sorting, updating, and merging training datasets and testing datasets. Updating may include insert new training data and new testing data into existing training and testing datasets, as well as removing data from existing training and testing datasets.

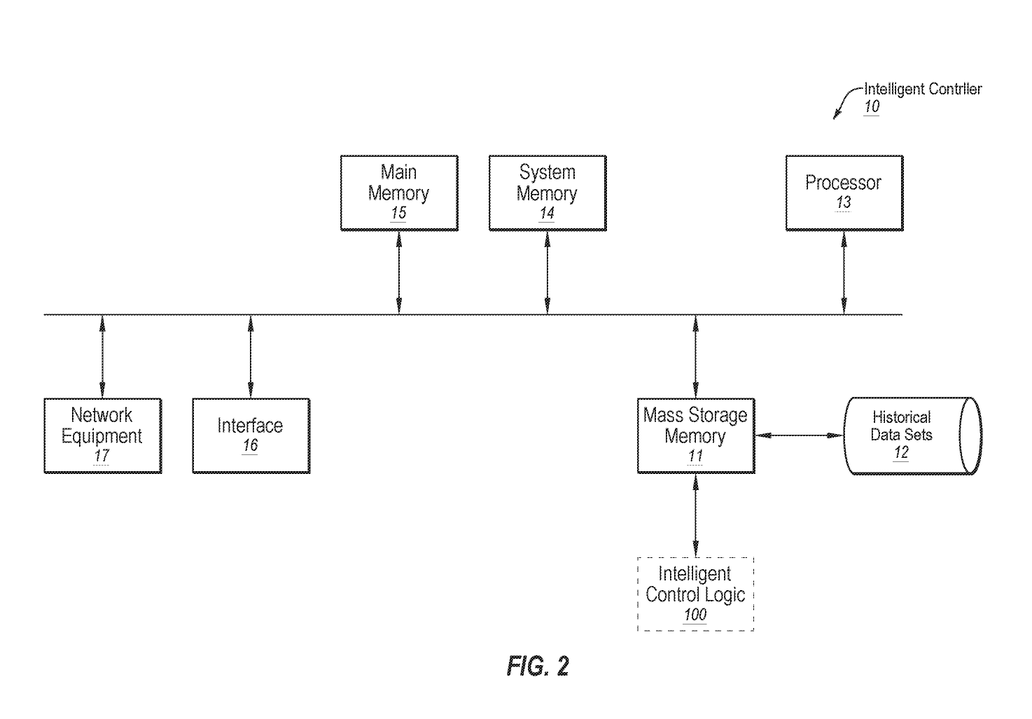

FIG. 2 illustrates an intelligent controller 10, in accordance with an embodiment of the disclosure. The intelligent controller 10 may include a mass storage memory 11, a processor 13, a system memory 14, a main memory 15, an interface 16, and network equipment 17. The mass memory storage 11 may have stored thereon one or more historical datasets 12 and intelligent control logic 100. The historical datasets 12 may include one or more of historical datasets, training datasets, and testing datasets. It will be readily understood that processor 13 may have access to historical datasets 12 when executing intelligent control logic 100.

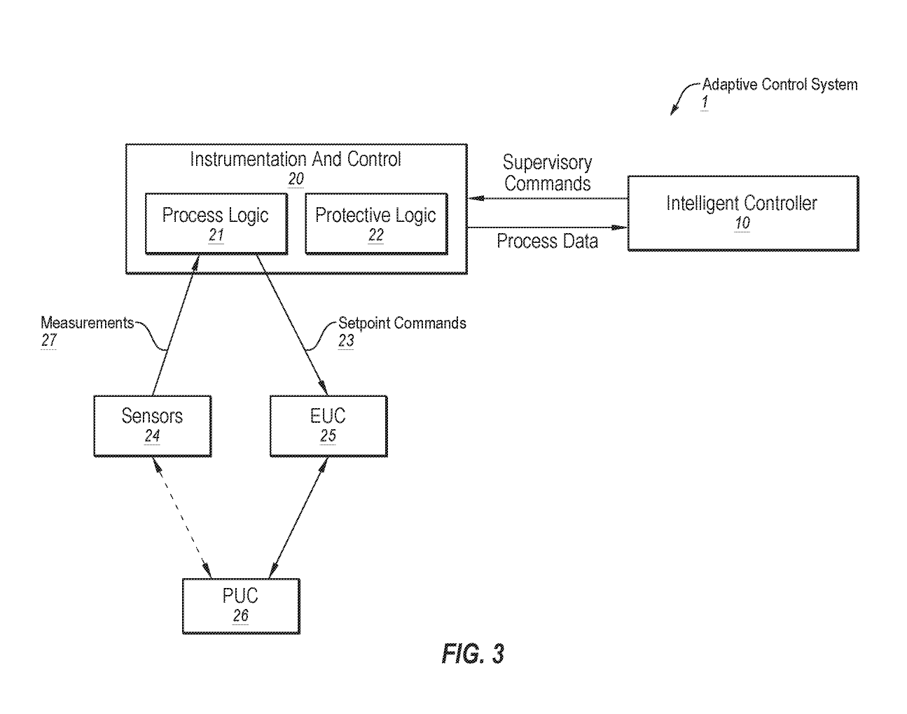

FIG. 3 illustrates an adaptive control system 1 that is integratable to a biomass processing system, for example, to monitor and control infeed processing, i.e., the equipment under control (EUC) 25 and process under control (PUC) 26.

The adaptive control system 1 may be configured to monitor a biomass processing system and its performance, monitor the condition of the infeed (e.g., moisture content), and control for in-situ adjustments to equipment process parameters (e.g., grinder infeed rate) to accommodate variability in the condition of the infeed. Embodiments of the adaptive control system 1 may include an intelligent controller 10, instrumentation and control 20, sensors 24, and EUC 25. Instrumentation and control 20 may include process logic 21 and protective logic 22.

In one or more embodiments, adaptive control system 1 may be optimized according to one or more optimization criteria 131. For example, if optimized according to a throughput definition 132, then the adaptive control system 1 may prioritize system runtime (i.e., uptime) responsive to upset conditions indicative of an overload or otherwise slowed throughput of infeed through system components. This may happen when a slug of infeed material passes through a processing system. A slug may be from a wet spot in a bale of infeed or when a section of the bale breaks loose during processing. It may also happen when a wetter than expected bale or section of bale is processed.

If optimized responsive to a quality definition 134, the adaptive control system 1 may prioritize the quality of the processed material to output a consistent, on-spec product even with infeed materials having variable conditions.

If optimized responsive to a reliability definition 131, the adaptive control system 1 may prioritize maximizing uptime of a biomass processing system and/or minimizing downtime.

In one embodiment, supervisory control may be integrated into embodiments of the intelligent controller 10, thus, intelligent controller 10 may be configured to provide supervisory commands to instrumentation and control 20, including commands that relate to EUC 25 and PUC 26.

Embodiments of the instrumentation and control 20 may be configured to receive and process inputs from the sensors 24, which may be configured to measure the state and condition of the EUC 25, the material entering the equipment, the material coming exiting the equipment, and the PUC 26, generally. In various embodiments, the EUC 25 may be any equipment that can affect the PUC 26, e.g., a motor or actuator that affects intake, and thus may include without limitation, motors, valves, actuators, fans, and the like. In various embodiments, the sensors 24 measuring the condition of the PUC 26 may measure without limitation, pressure, moisture, flow, level, temperature, alarms, status, strain, vibration, current, and the like. The sensor 24 may be any component, module, or subsystem having electronics configured to detect a condition or change external to the sensor, and store and/or transmit information about the detected condition or change. Embodiments of the sensor 24 may including a sensing component, module, or subsystem coupled to the electronics that responds to the condition or change. In various embodiments, the sensing component(s) may be visual (e.g., for particle size), hyperspectral (e.g., for moisture, composition, etc.), thermal (e.g., temperature, etc.), and combinations thereof. Examples of sensing components include, a photodetector, fiber Bragg gratings, fiber optics, capacitive sensitive circuitry, force sensitive resistors, a spring, a circuit responding to resistivity and conductance changes, and combinations thereof.

In various embodiments, the measurements 27 that the sensors 24 provide to instrumentation and control 20 may include measurements indicative of the operation of a biomass processing equipment and measurements indicative of the condition of the infeed material before, during and after it is processed. For example, measurements indicative of the operation of the biomass processing equipment may include current to a motor driving a conveyor, conveyor state (e.g., locked, operational), intake capacity (e.g., remaining volume of an intake bin, room on an intake conveyor), and grinder state (e.g., locked, operational). Further, measurements indicative of the condition of the infeed material may include measurements of the moisture content of the infeed material and the weight of the infeed material.

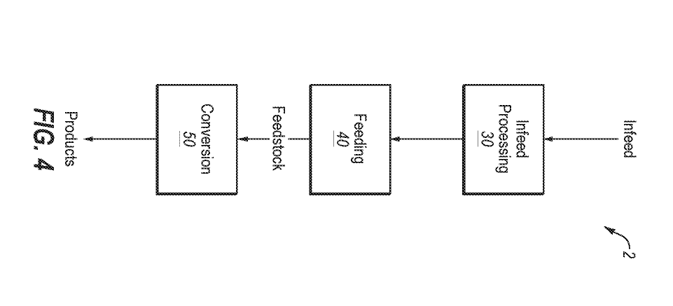

FIG. 4 illustrates a biomass processing system 2 where the input is infeed material and the output is a solid, liquid, or gaseous product such as pellets, biofuels, chemicals, or some other industrial bio-product, in accordance with an embodiment of the disclosure. The stages of the biomass processing system 2 include a infeed processing 30, a feeding 40 (e.g., densification), and conversion 50.

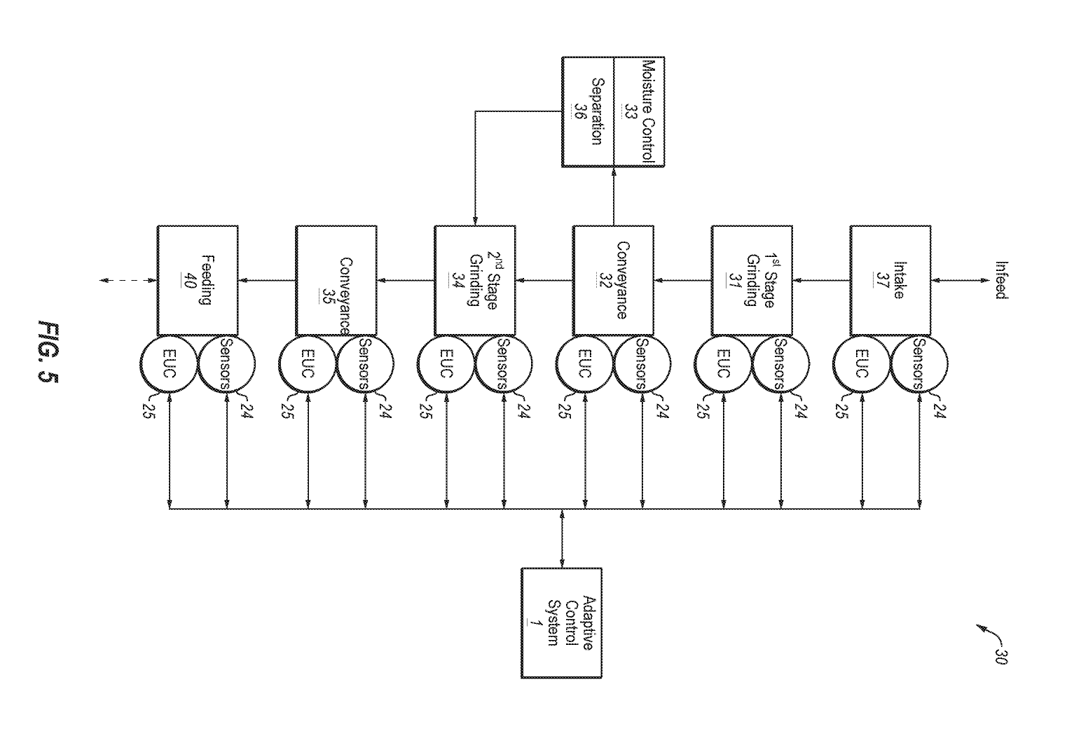

FIG. 5 illustrates an infeed processing system 30 with integrated adaptive control system 1, in accordance with an embodiment of the disclosure. Embodiments of the adaptive control system 1 are not limited to infeed processing and may be incorporated into other processing stages, including feeding and conversion, as well as other stages that may be introduced into a biomass processing systems.

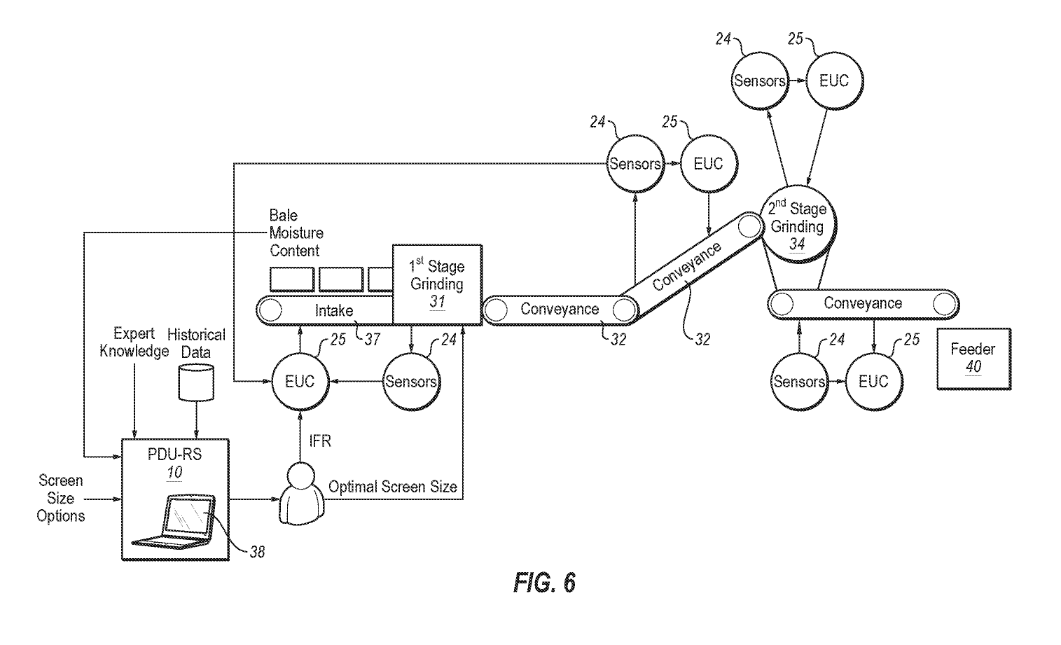

In various embodiments, the infeed processing system 30 may processes infeed material to reduce bales of infeed, preferably to particles of predefined size distribution (though particle sizes may vary). FIG. 5 illustrates one embodiment of a particle reduction process that includes two stages, first stage grinding 31 and second stage grinding 34. An intake 37 (see FIG. 6) may receive bales at the first stage grinder 31. In various embodiments, the intake 37 may be a bin/chute or a conveyor like a drag conveyor. The first stage grinding 31 and second stage grinding 34 may be performed by, for example, a hammermill, a knife mill, a shear mill, and combinations thereof.

In some embodiments, sensors 24 disposed at the intake 37 for grinder 31 may measure one or more conditions of the infeed bales, for example, the weight and/or the moisture content. A conveyance 32 may move the ground infeed output from grinder 31 to grinder 34. In one embodiment, the conveyance 32 is a conveyor belt, though it is not so limited and may be a chute, slide or some other conveyance means that is known to one having ordinary skill in the art. In one embodiment, sensors 24 may also be disposed at one or more grinders 31 and 34, and the conveyances 32 and 35. In one embodiment, the sensors 24 disposed at the grinders 31 and 34 may be configured to collect measurements indicative of one or more of a motor current, a state of the equipment, and one or more conditions of infeed material. In one embodiment, the sensors 24 disposed at the conveyances 32 and 35 may be configured to collect measurements indicative of one or more conditions of the infeed material/processes infeed material (e.g., moisture content, weight, etc.), motor current, and a state of the conveyors.

In one embodiment, the infeed processing system 30 may route deconstructed infeed output from grinder 31 to moisture control 33 responsive to one or more measurements, for example, an infeed moisture content measurement or an operational measurement of the grinder that is indicative of moisture content. In yet other embodiments, the infeed processing system 30 may include feeding 40 for storage before the feeding process 40. A conveyance 35 may convey the infeed particles to the feeding 40. In one embodiment, the conveyance 35 is a screw conveyor, drag chain, or pneumatic conveyor.

In one embodiment, the infeed processing system 30 may route deconstructed infeed output from grinder 31 to a separator XYZ responsive to one or more measurements, for example, a measurement indicative of contaminant. The separator XYZ may be configured to remove foreign materials or other contaminants.

In various embodiments, the grinders 31 and 34 may include grinding screens (not shown). The first stage grinder 31 may be configured to use several different screen size openings, for example, about 6 inches, 4 inches, 3 inches, and 1 inch. The second stage grinder 31 may also be configured to use several different screen sizes, which may be the same or different than the screen sizes of the first stage grinder 31. For example, the second stage grinder 34 may have screen sizes of 2 inches, 1 inch, and a ¼ inch.

In various embodiments, the screens may comprise two or more screens with through holes. The grinder screens may be arranged serially touching or very close to each other. The grinder screens may be operably coupled to an actuator that can move at least one of the screens relative to one or more other screens. If the areas of the openings of each through hole of each screen completely overlap then that would represent the largest opening for the combination of those two openings. Starting from an arrangement where areas completely overlap, moving the screens relative to each other reduces the size of the opening of the combination of the through holes for the two screens. Each screen may define multiple through holes of different sizes. Each screen may define a different pattern of through holes than one or more other screens.

The infeed rate and the screen sizes are two operational conditions that may be parameterized as adjustable control variables to control the operation of the infeed processing system 30. Moisture content of an infeed bale may have a significant effect on the infeed processing system 30. In some embodiments, these control variables may be defined as a function of the moisture content of an infeed bale.

FIG. 6 illustrates the operation of the infeed processing system 30 with integrated adaptive control system 1, in accordance with an embodiment of the disclosure. In this embodiment, the infeed processing is carried out in a series of sequential operations (e.g., a process flow); however, one of ordinary skill in the art will recognize that embodiments of the adaptive control system 10 are applicable to other arrangements. Raw bales are first introduced to grinder 31. The bale weight and the bale moisture content may be measured just before the bale is introduced to the grinder 31. In one embodiment, sensors 24 that are configured to measure the bales may be integrated into the bale conveyor 37. By way of example, sensors 24 may be a current transducer (IT). Grinder 31 outputs ground infeed onto drag conveyors 32. EUC 25 may control the speed of the conveyor through a speed control (SC) device—for example, a variable frequency drive or a cross-line starter. The drag conveyors 32 transfer ground infeed to grinder 34. Grinder 34 outputs reduced infeed particles to the conveyor 35.

Various EUC 25 and sensors 24 may be operatively and/or communicatively coupled to the intelligent controller 10. The intelligent controller 10 may be coupled to an operator 38. In one embodiment, the operator 38 may be a workstation having a dashboard that enables a human to interact with the intelligent controller 10 and the adaptive control system 1. In another embodiment, the operator 38 may be an autonomous operator that automatically generates operator commands responsive to operational predictions and recommended control parameters. The autonomous operator may generate operator commands responsive to the recommended control parameters. In yet another embodiment the operator 38 may be an artificial intelligence unit or module that generates operator commands responsive to operational predictions and recommended control parameters. In one embodiment, the adaptive control module 120 may be an autonomous unit that is responsible for the operator function, and a separate operator 38 is omitted or included only for setup and maintenance of the intelligent controller 10 and the adaptive control system 1.

In one or more embodiments, one or more elements of intelligent controller 10 may be implemented in a front office at a processing center, a mobile office (e.g., a truck or van), or a remote office that is operatively coupled to the system via one or more networks.

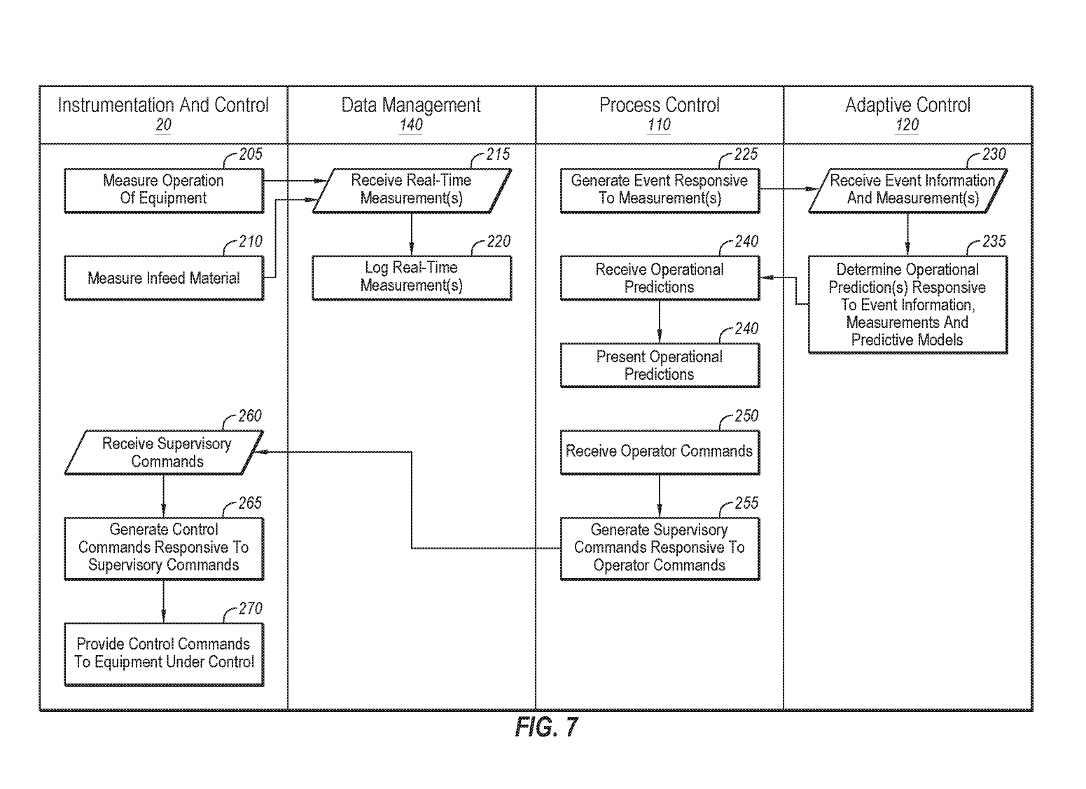

FIGS. 7, 8 and 9 illustrates contemplated operations of an adaptive control system 10, including various aspects of the data driven modeling and recommendation functionality, in accordance with embodiments of the disclosure.

FIG. 7 illustrates an operation of the adaptive control system 10 integrated with an infeed processing system 30, in accordance with an embodiment of the disclosure. Instrumentation and control 20 receives one or more measures of the operation of the equipment of the infeed processing system 30 and measurements indicative of the condition of the infeed material, in operation 205 and operation 210. Instrumentation and control 20 provides the measurements to the intelligent controller 10, which are received by the data management module 140 in operation 215. Data management module 140 logs and stores the measurements in operation 220.

Process control module 110 generates an event responsive to the measurements in operation 225. In one embodiment, process control module 110 generates an event responsive to a comparison of one or more of the measurements to one or more thresholds. For example, a measurement of the current provided to a grinder that is outside an operational range may indicate that the grinder is not operating properly. By way of another example, particle size measurements outside an operational range or weight measurements of processed infeed outside an expected range may indicate that the infeed processing system 30 is not operating within a desired operational range.

An event handler (not shown) may communicate the event to the adaptive control module 120 and the event information and measurements are received at the adaptive control module 120 in operation 230. The adaptive control module 120 may determine one or more operational predictions responsive to one or more predictive models, the received event information and measurements, in operation 235. The adaptive control module 120 may load one or more predictive models from memory responsive to one or more of the received event information and measurements. In one embodiment, the operational predictions may include an estimate indicative of capacity, reliability, quality or energy.

The process control module 110 receives the operational predictions in operation 240, and presents the operational predictions in operation 245. In one embodiment, the process control module 110 presents the operational predictions to a dashboard that is accessible by an operator. The operator may manipulate the dashboard to provide one or more operator commands to the process control module 110, including responsive to the presented operational predictions. The process control module 110 receives one or more operator commands in operation 250, and generates one or more supervisory commands responsive to the received operator commands in operation 255, and provides those supervisory commands to instrumentation and control 20.

The instrumentation and control 20 receives the supervisory commands in operation 260, and generates one or more control commands (e.g., set-point commands) responsive to the received supervisory commands in operation 265. The instrumentation and control 20 sends the control commands to one or more of the EUC 25 in operation 270.

Though FIG. 7 is described in terms using event-driven communication between the various modules, it is specifically contemplated that other techniques of asynchronous and synchronous communication may be used and incorporated into the adaptive control system 10.

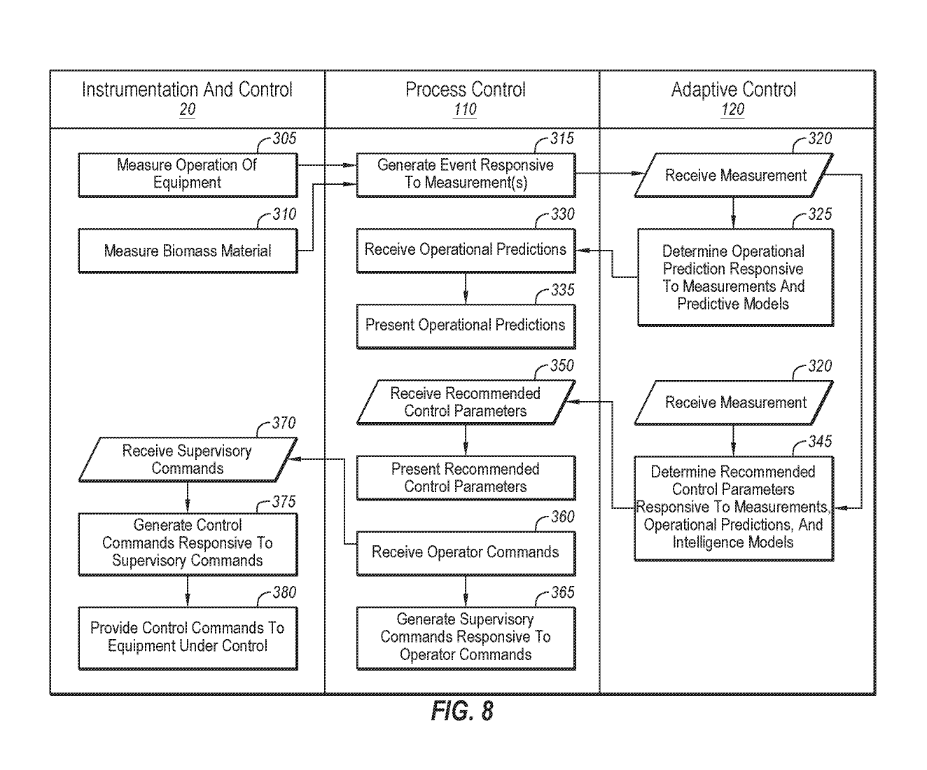

FIG. 8 illustrates an operation of the adaptive control system 10 integrated with an infeed processing system 30, which incorporates recommendation intelligence, in accordance with an embodiment of the disclosure. The data management module 140 is omitted in FIG. 8 to simplify the diagram.

Instrumentation and control 20 receives one or more of measurements of the operation of the equipment of the infeed processing system 30 and measurements indicative of the condition of the infeed material, in operation 305 and operation 310. Instrumentation and control 20 provides the measurements to the process control module 110 and process control module 110 generates an event responsive to the received measurements in operation 315. The events are communicated to the adaptive control module 120, and event information and the measurements are received in operation 320.

The adaptive control module 120 may determine one or more operational predictions responsive to one or more predictive models, the received event information and measurements, in operation 325. The adaptive control module 120 may load one or more predictive models from memory responsive to one or more of the received event information and measurements. In one embodiment, the operational predictions may include an estimate indicative of capacity, reliability, quality or energy.

The adaptive control module 120 may also determine one or more recommended control parameters relevant to the process control module 110. The adaptive control module 120 may receive one or more optimization parameters in operation 340. The adaptive control module 120 may determine one or more recommended control parameters responsive to one or more of the measurements, event information, operational predictions, and one or more intelligence models in operation 345. The recommended control parameters may include process condition adjustments, operational condition adjustments, or be indicative of process condition adjustments or operational condition adjustments. For example, the recommended control parameters may be a recommended adjustment to an infeed rate, a setting for an operational parameter (e.g., motor rpm and the expected adjustment), or combinations thereof. In one embodiment, the recommended control parameters may be set-point commands. In one embodiment the adaptive control module 120 may load the one or more intelligence models from memory responsive to one or more of the event information, measurements, and operational predictions. In one embodiment, the recommended control parameters may be indicative of an infeed rate, motor rotations per minute (rpm), air flow, intake screen size, moisture control routing, or any other control parameter, the adjustment of which would affect operation of the infeed processing system 30.

The process control module 110 receives the operational predictions in operation 330, and presents the operational predictions in operation 335. The process control module 110 receives the recommended control parameters in operation 350, and presents the recommended operational control parameters in operation 355.

In one embodiment, the process control module 110 presents the operational predictions and recommended control parameters to a dashboard that is accessible by an operator. The operator may manipulate the dashboard to provide one or more operator commands to the process control module 110, including responsive to the presented operational predictions and recommended control parameters. The process control module 110 receives one or more operator commands in operation 360, generates one or more supervisory commands responsive to the received operator commands in operation 365, and provides those supervisory commands to instrumentation and control 20.

The instrumentation and control 20 receives the supervisory commands in operation 370, and generates one or more control commands (e.g., set-point commands) responsive to the received supervisory commands in operation 375. The instrumentation and control 20 sends the control commands to one or more of the EUC 25 in operation 380.

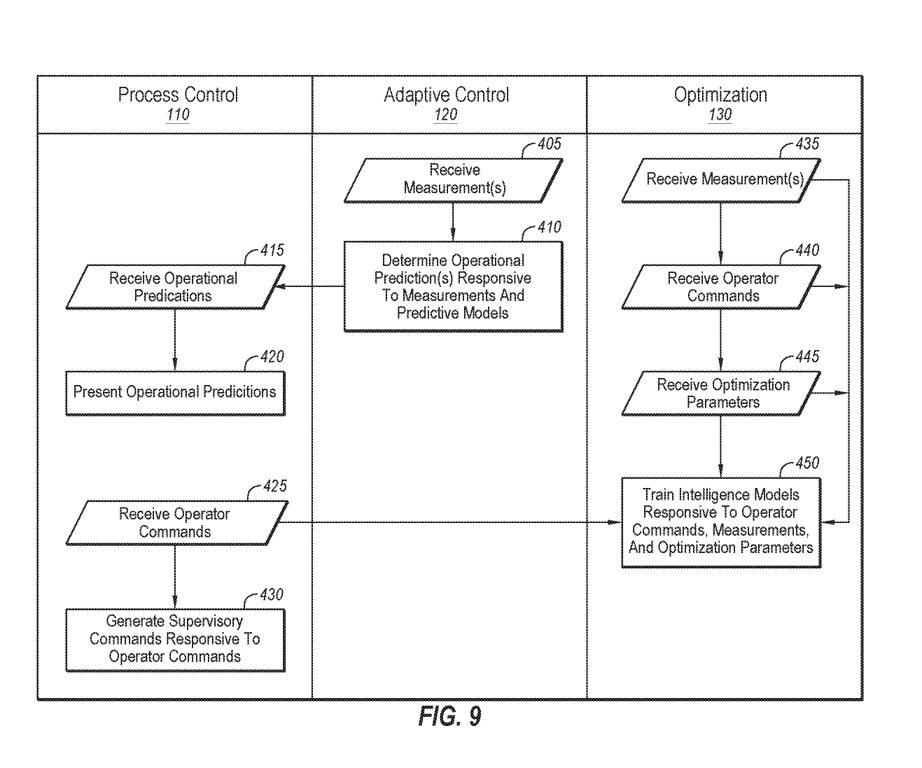

FIG. 9 illustrates an operation of the adaptive control system 10 integrated with an infeed processing system 30, which incorporates updating intelligence models in accordance with an embodiment of the disclosure. The adaptive control module 120 receives the measurements in operation 405, and determines one or more operational predictions responsive to the measurements and one or more predictive models in operation 410. Process control module 110 receives the operational predictions in operation 415, and presents the operational predictions (e.g., to an operator dashboard) in operation 420. The process control module 110 receives one or more operator commands, for example, responsive to the presented operational predictions, in operation 425, and generates one or more supervisory commands responsive to the operator commands in operation 430.

The optimization module 130 receives one or more of the measurements, operator commands, and optimization parameters in operations 435, 440, and 445. The optimization module 130 may train the intelligence models responsive to one or more of the received measurements, operator commands, and optimization parameters, in operation 450. In one embodiment, the optimization module 130 updates one or more training datasets and/or testing datasets responsive to the received operator commands and the measurements. For example, an operator command may be indicative of a process condition (e.g., an infeed rate), and the measurement may be indicative of the condition of the infeed material (e.g., moisture content). The adaptive control system 30 may have one or more intelligence models of the process condition as a function of the condition of the infeed material (e.g., infeed rate as a function of moisture content). Those intelligence models may have been generated with one or more training datasets and/or testing datasets stored, for example, with the historical datasets 12 (see FIG. 2). The optimization module 130 may update those training datasets and testing datasets with parameterized process conditions and conditions of the infeed material. New or updated intelligence models may be trained responsive to the new or updated training datasets and testing datasets.

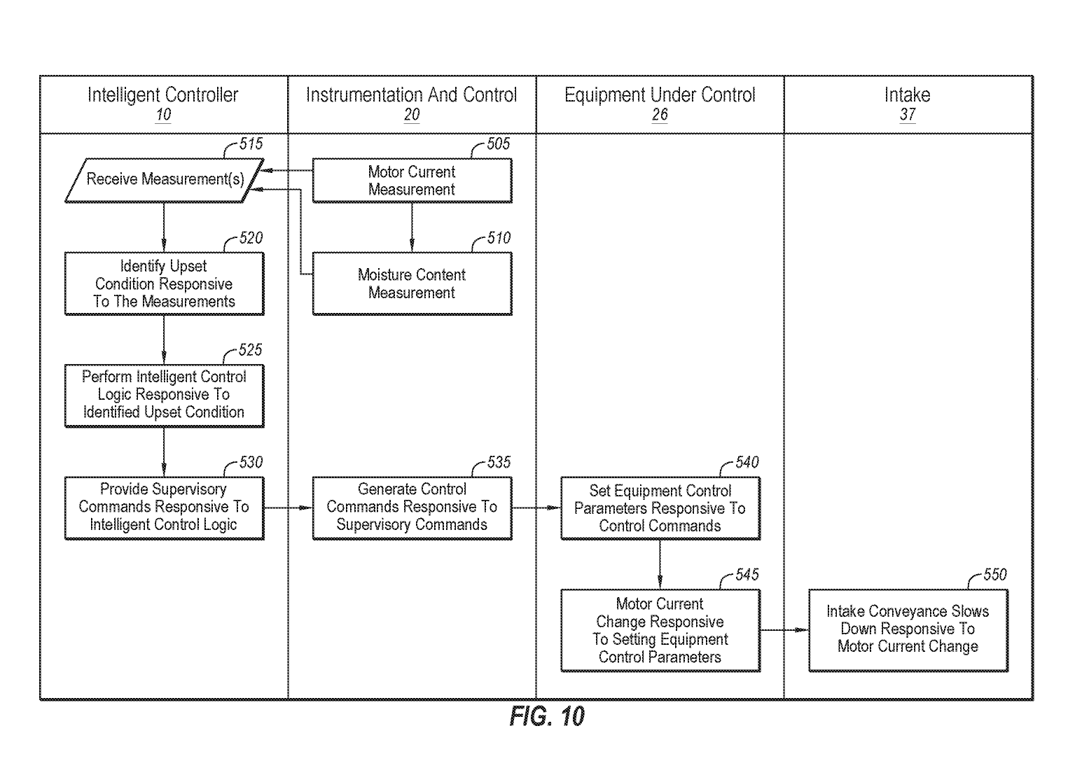

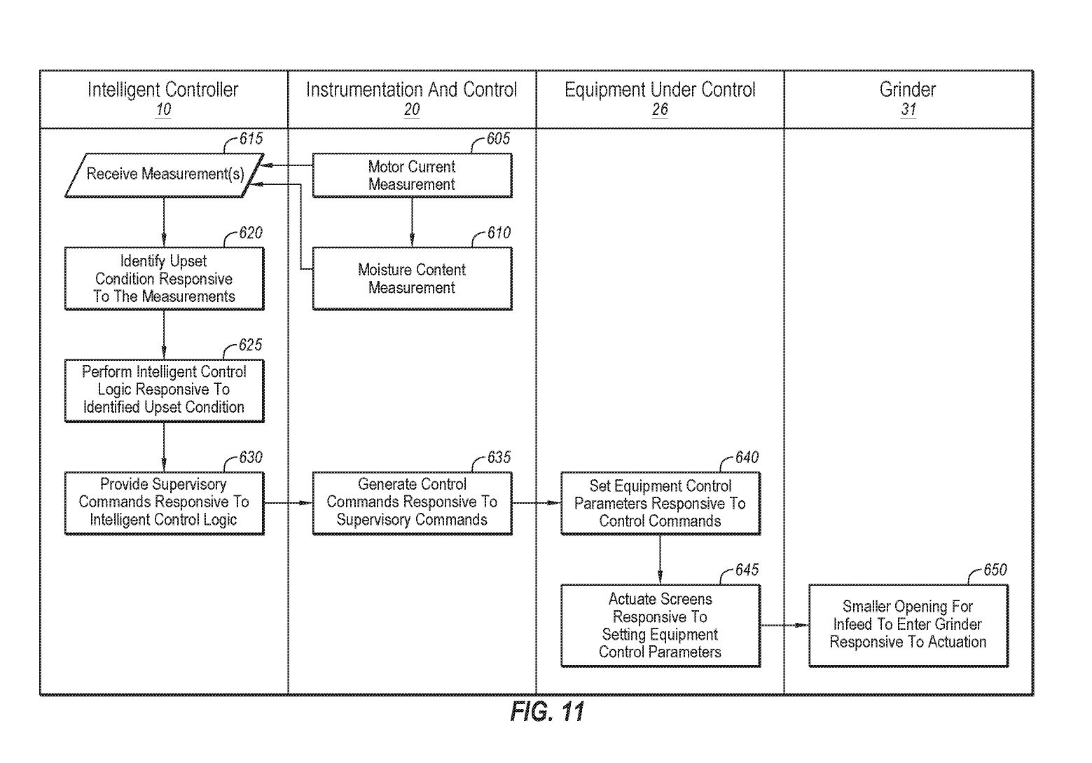

FIGS. 10 and 11 illustrate the operation of the infeed processing system 30 with integrated adaptive control system 10, including various aspects of the operation in the event of certain operational conditions and infeed material conditions.

FIG. 10 illustrates the operation of the infeed processing system 30 with integrated adaptive control system 10, in accordance with an embodiment of the disclosure. Instrumentation and control 20 receive a motor current measurement in operation 505 and moisture content measurement in operation 510. Instrumentation and control 20 provides the measurements to the intelligent controller 10, which receives the measurements in operation 515. The intelligent controller 10 identifies one or more upset conditions responsive to the measurements in operation 520. In one embodiment, the intelligent controller 10 identifies the upset condition responsive to determining that the moisture content measurement is outside an operational range. The intelligent controller 10 performs intelligent control logic responsive to the identified upset conditions in operation 525, and generates one or more supervisory commands responsive to the intelligent control logic in operation 530. In one embodiment, the supervisory commands are configured to effect a change in a processing condition of the infeed processing system 30 in a manner that will resolve the upset condition, for example, to accommodate the moisture content of the infeed material. Instrumentation and control 20 generates one or more control commands responsive to the received supervisory commands in operation 535 and provides the control commands to the EUC 26.

One or more equipment control parameters are set at the EUC 26 responsive to receiving the control commands in operation 540. A motor current in the EUC 26 changes responsive to setting the equipment control parameters 545 in operation 545. The speed of the intake 37 to the grinder 31, responsive to the change current to the motor, adjusts in operation 550, and slows down the infeed rate at the Grinder 31. The slower infeed rate accommodates the moisture content of the infeed material.

FIG. 11 illustrates the operation of the infeed processing system 30 with integrated adaptive control system 10, in accordance with an embodiment of the disclosure. Instrumentation and control 20 receive a motor current measurement in operation 605 and moisture content measurement in operation 610. Instrumentation and control 20 provides the measurements to the intelligent controller 10, which receives the measurements in operation 615. The intelligent controller 10 identifies one or more upset conditions responsive to the measurements in operation 620. In one embodiment, the intelligent controller 10 identifies the upset condition responsive to determining that the moisture content measurement is outside an operational range. The intelligent controller 10 performs intelligent control logic responsive to the identified upset conditions in operation 625, and generates one or more supervisory commands responsive to the intelligent control logic in operation 630. In one embodiment, the supervisory commands are configured to effect a change in a processing condition of the infeed processing system 30 in a manner that will resolve the upset condition, for example, accommodating the moisture content of the infeed material. Instrumentation and control 20 generates one or more control commands responsive to the received supervisory commands in operation 635 and provides the control commands to the EUC 26.

One or more equipment control parameters are set at the EUC 26 responsive to receiving the control commands in operation 640. An actuator in the EUC 26 adjusts responsive to setting the equipment control parameters in operation 645. The size of an opening in a grinder screen of the grinder 31 changes in operation 650, responsive to the actuation, which changes the residence time of biomass in the Grinder 31. A larger screen opening accommodates the higher moisture content of the infeed material.

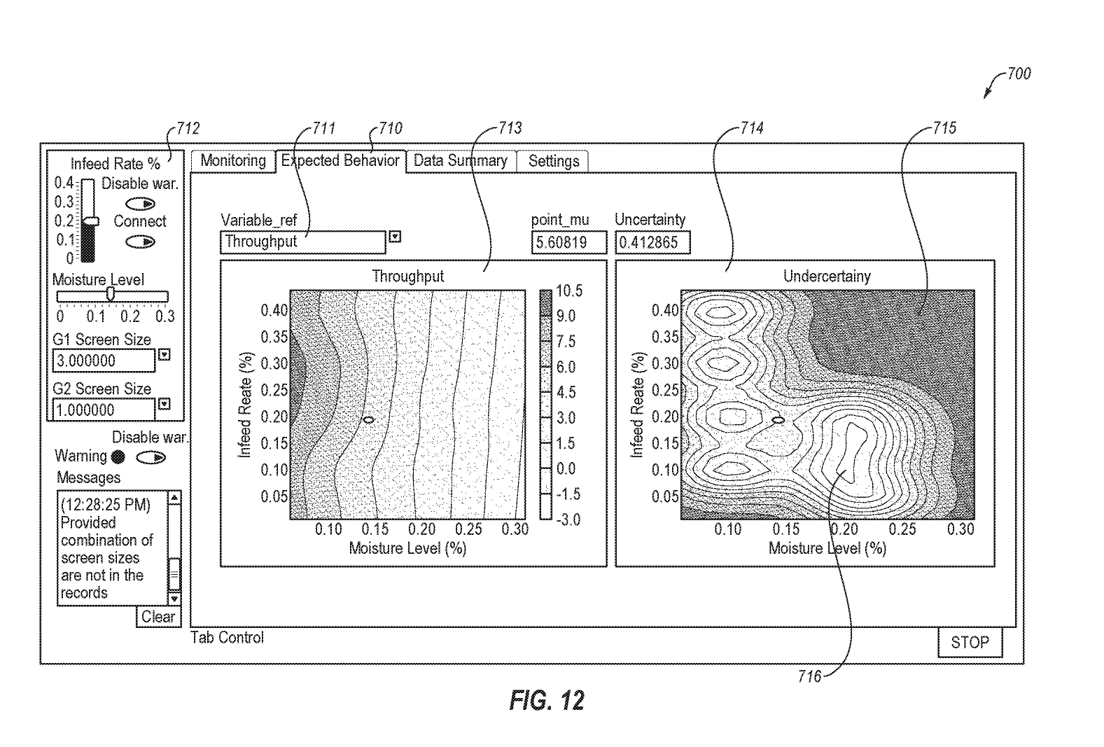

FIG. 12 illustrates a dashboard 700 that interfaces with the intelligent controller 10 and intelligent control logic 100, in accordance with an embodiment of the disclosure. The active window 710 of the dashboard 700 provides a visual depiction of estimates generated by the intelligent controller 10 with the predictive models. The embodiment of the active window 710 is comprised of a variable selection region 711, settings 712, and interactive models 713 and 714. The settings 712 include fixed variables, for example, the grinder screen size (e.g., diameter of the opening). In one embodiment, one or more of the settings 712 may comprise the operator commands provided by the operator to the intelligent controller 10.

The interactive models 713 and 714 are displayed responsive to the parameters selected in the variable selection region 711 and the settings 712. “Throughput” is selected in the variable selection region 711, thus, the interactive model 713 is a model of the throughput as a function of infeed rate and moisture content. Examples of other variable selections include current on grinders and conveyors, standard deviation of the currents for grinders and conveyors, percentage of active time for grinders and conveyors, mass-flow on a conveyor, and thermal capacity of a motor.

The interactive model 713 illustrated in FIG. 12 is a Gaussian process model, however, other data-driven models may be used to generate the interactive model 713. Gaussian process provides a data-efficient model to obtain the estimates of performance and reliability (or other optimization parameter) as well as the uncertainty of the estimates.

The interactive model 714 is an illustration of the uncertainty associate with the interactive model 713. Providing the uncertainty of the estimations may enable an operator to visualize the defined configuration parameters. Uncertainty enables the intelligent control logic 100 to provide estimates on regions outside the configured parameters, while indicating that the estimates might by incorrect. In one embodiment uncertainty is presented normalized between zero and one, where low uncertainty corresponds to regions where historical data of the process under control is available. The red regions 715 correspond to higher uncertainty, and the blue regions 716 correspond to lower uncertainty.

Any characterization in this disclosure of something as ‘typical,’ ‘conventional,’ or ‘known’ does not necessarily mean that it is disclosed in the prior art or that the discussed aspects are appreciated in the prior art. Nor does it necessarily mean that, in the relevant field, it is widely known, well-understood, or routinely used.

The features of the various embodiments described herein are not mutually exclusive and can exist in various combinations and permutations, even if such combinations or permutations are not expressly described herein, without departing from the scope of the disclosure. In fact, variations, modifications, and other implementations of what is described herein will occur to one of ordinary skill in the art without departing from the scope of the disclosure. As such, the invention is not to be defined only by the preceding illustrative description, but only by the claims which follow, and legal equivalents thereof.

Additional non-limiting embodiments of the disclosure include:

Embodiment 1: a process control system, comprising: a first controller operable to monitor and control a material processing system; and a second controller operable to: generate supervisory commands configured to effectuate a change by the first controller in the material processing system; and estimate one or more performance conditions of a controlled process of the material processing system responsive to a predictive model, a material condition measurement, and an operational measurement, wherein: the material condition measurement is indicative of a condition of a physical material undergoing the controlled process of the material processing system; and the operational measurement is indicative of an operation of the material processing system during the controlled process.

Embodiment 2: the process control system of Embodiment 1, wherein the second controller is further operable to determine one or more process condition adjustments to effectuate a change in the material processing system.

Embodiment 3: the process control system of any of Embodiments 1 and 2, wherein the second controller determines the one or more process condition adjustments responsive to an intelligence model, the material condition measurement, and the operational measurement.

Embodiment 4: the process control system of any of Embodiments 1 through 3, wherein one or more of the predictive model and the intelligence model is a heuristic model.

Embodiment 5: the process control system of any of Embodiments 1 through 4, wherein the intelligence model is one or more of a fuzzy logic model and a neural network model.

Embodiment 6: the process control system of any of Embodiments 1 through 5, wherein predictive model is a Gaussian process.

Embodiment 7: the process control system of any of Embodiments 1 through 6, wherein the intelligence model comprises at least one heuristic model and at least one process model.

Embodiment 8: the process control system of any of Embodiments 1 through 7, further comprising one or more historical datasets, the datasets comprising data indicative of historical performance of the material processing system, and data indicative of one or more historical operational conditions of the material processing system.

Embodiment 9: the process control system of any of Embodiments 1 through 8, wherein the historical performance comprises measures that are indicative of one or more of reliability, throughput, quality, and energy.

Embodiment 10: the process control system of any of Embodiments 1 through 9, wherein the one or more historical operational conditions comprise one or more of steam, pellet cooling time, and material size.

Embodiment 11: the process control system of any of Embodiments 1 through 10, wherein the one or more historical operational conditions comprise one or more of type of chemical, amount of chemical, amount of heat time, and amount of dwell time.

Embodiment 12: the process control system of any of Embodiments 1 through 11, wherein the one or more historical operational conditions comprise one or more of rotor speed, air flow, infeed rate and grinder screen size.

Embodiment 13: the process control system of any of Embodiments 1 through 12, wherein the physical material is physical matter.

Embodiment 14: the process control system of any of Embodiments 1 through 13, wherein the physical matter is biomass.

Embodiment 15: the process control system of any of Embodiments 1 through 14, wherein the material processing system is a biomass processing system.

Embodiment 16: the process control system of any of Embodiments 1 through 15, wherein the material processing system is an infeed processing system adapted to deconstruct infeed for conversion to solid, liquid, or gaseous products.

Embodiment 17: the process control system of any of Embodiments 1 through 16, wherein the material processing system is a feeding system adapted to feed deconstructed material for conversion to solid, liquid or gaseous products.

Embodiment 18: the process control system of any of Embodiments 1 through 17, wherein the material processing system comprises: an infeed processing system adapted to deconstruct infeed; and a feeding system adapted to feed deconstructed material.

Embodiment 19: a process controller, comprising: a data management module configured to receive one or more measurements indicative of a controlled process of an infeed processing system; a prediction module configured to generate estimates of a performance of the controlled process responsive to a predictive model and the one or more measurements indicative of the controlled process; and an intelligence module configured to generate process condition adjustments responsive to an intelligence model and the one or more measurements indicative of the controlled process.

Embodiment 20: the process controller of Embodiment 19, further comprising a process control module configured to generate commands configured to effectuate a change in the infeed processing system, wherein the commands are generated responsive to one or more of the estimates and the process condition adjustments.

Embodiment 21: the process controller of any of Embodiments 19 and 20, further comprising an optimization module configured to provide one or more optimization parameters.

Embodiment 22: the process controller of any of Embodiments 19 through 21, wherein the predictive model associates at least one of the one or more optimization parameters to one or more of a condition of the infeed processing system and a condition of infeed material.

Embodiment 23: the process controller of any of Embodiments 19 through 22, wherein the intelligence model associates at least one of the one or more optimization parameters to at least one process condition of the infeed processing system.

Embodiment 24: the process controller of any of Embodiments 19 through 23, further comprising a database of historical datasets the datasets comprising data indicative of historical performance of the infeed processing system, and data indicative of one or more historical operational conditions of the infeed processing system.

Embodiment 25: the process controller of any of Embodiments 19 through 24, wherein the data management module is configured to update the historical datasets responsive to the one or more measurements.

Embodiment 26: a method of controlling a process, comprising: calculating one or more performance estimates of a controlled material deconstruction process responsive to a first computer heuristic model and at least one measurement indicative of one or more electronically observed conditions of the controlled material deconstruction process; calculating one or more process condition adjustments responsive to a second computer heuristic model, at least one upset condition, and the at least one measurement; and generating a command responsive to the one or more process condition adjustments, the command comprising one or more parameters to effectuate a change in the controlled material deconstruction process.

Embodiment 27: the method of Embodiment 26, further comprising identifying the upset condition responsive to a comparison of the at least one measurement to a pre-defined threshold.

Embodiment 28: the method of any of Embodiments 26 and 27, further comprising presenting one or more of performance estimates and the one or more process condition adjustments to a dashboard.

Embodiment 29: the method of any of Embodiments 26 through 28, further comprising receiving an operator command and generating the command at least in part on the received operator command.

Embodiment 30: the method of any of Embodiments 26 through 29, further comprising updating a historical dataset responsive to the received operator command.

Embodiment 31: the method of any of Embodiments 26 through 30, wherein updating the historical dataset further comprises updating one or more training datasets and testing datasets.

Embodiment 32: a system, comprising: a biomass processing system; and a control system, the control system comprising: a first controller operable to monitor and control the biomass processing system; and a second controller operable to: generate supervisory commands configured to effectuate a change by the first controller in the biomass processing system; and estimate one or more performance conditions of a controlled process of the biomass processing system responsive to a predictive model, an infeed condition measurement, and an operational measurement, wherein, the infeed condition measurement is indicative of a condition of infeed material undergoing the controlled process of the biomass processing system, and the operational measurement is indicative of an operation of the biomass processing system during the controlled process.

Embodiment 33: the system of Embodiment 32, wherein the biomass processing system comprises a deconstruction component operable to deconstruct biomass material.

Embodiment 34: the system of any of Embodiments 32 and 33, wherein the deconstruction component comprises one or more grinders.

Embodiment 35: the system of any of Embodiments 32 through 34, wherein at least one of the one or more grinders is one or more of a hammermill, a knife mill, a shear mill, and combinations thereof.

Embodiment 36: the system of any of Embodiments 32 through 35, wherein the controlled process is an infeed process for deconstructing physical matter.

Embodiment 37: the system of any of Embodiments 32 through 36, wherein the physical matter is organic matter.

Embodiment 38: the system of any of Embodiments 32 through 37, wherein the condition of infeed material comprises one or more of a moisture content of the infeed and a weight of the infeed.

Embodiment 39: the system of any of Embodiments 32 through 38, wherein the biomass processing system comprises at least one deconstruction stages and at least one conveyance stage, wherein one or more of the deconstruction stages and the conveyance stage are controllable to change an infeed rate of the biomass processing system.

Embodiment 40: the system of any of Embodiments 32 through 39, wherein the biomass processing system comprises a deconstruction stage, a feeding stage, and a conversion stage.

Embodiment 41: the system of any of Embodiments 32 through 40, wherein the control system further comprises: a first sensor disposed within proximity to the biomass processing system and operable to measure a condition of infeed conveyed through the biomass processing system; and a second sensor disposed within proximity to the biomass processing system and operable to measure an operational condition of at least one equipment of the biomass processing system.

Embodiment 42: the system of Embodiment 41, wherein the operational condition of at least one equipment is one or more of a motor current and a state of the at least one equipment.

We claim:

1. A process control system, comprising:
a first controller operable to monitor and control a material processing system; and
a second controller operable to:
generate supervisory commands configured to effectuate a change by the first controller in the material processing system; and
estimate one or more performance conditions of a controlled process of the material processing system responsive to a predictive model, a material condition measurement, and an operational measurement,
wherein:
the material condition measurement is indicative of a condition of a physical material undergoing the controlled process of the material processing system; and
the operational measurement is indicative of an operation of the material processing system during the controlled process.

2. The process control system of claim 1, wherein the second controller is further operable to determine one or more process condition adjustments to effectuate a change in the material processing system.

3. The process control system of claim 2, wherein the second controller determines the one or more process condition adjustments responsive to an intelligence model, the material condition measurement, and the operational measurement.

4. The process control system of claim 3, wherein one or more of the predictive model and the intelligence model is a heuristic model.

5. The process control system of claim 4, wherein the intelligence model is one or more of a fuzzy logic model and a neural network model.

6. The process control system of claim 4, wherein predictive model is a Gaussian process.

7. The process control system of claim 3, wherein the intelligence model comprises at least one heuristic model and at least one process model.

8. The process control system of claim 1, further comprising one or more historical datasets, the datasets comprising data indicative of historical performance of the material processing system, and data indicative of one or more historical operational conditions of the material processing system.

9. The process control system of claim 8, wherein the historical performance comprises measures that are indicative of one or more of reliability, throughput, quality, and energy.

10. The process control system of claim 8, wherein the one or more historical operational conditions comprise one or more of steam, pellet cooling time, and material size.

11. The process control system of claim 8, wherein the one or more historical operational conditions comprise one or more of type of chemical, amount of chemical, amount of heat time, and amount of dwell time.

12. The process control system of claim 8, wherein the one or more historical operational conditions comprise one or more of rotor speed, air flow, infeed rate and grinder screen size.

13. The process control system of claim 1, wherein the physical material is physical matter.

14. The process control system of claim 13, wherein the physical matter is biomass.

15. The process control system of claim 1, wherein the material processing system is a biomass processing system.

16. The process control system of claim 1, wherein the material processing system is an infeed processing system adapted to deconstruct infeed for conversion to solid, liquid, or gaseous products.

17. The process control system of claim 1, wherein the material processing system is a feeding system adapted to feed deconstructed material for conversion to solid, liquid or gaseous products.

18. The process control system of claim 1, wherein the material processing system comprises:
an infeed processing system adapted to deconstruct infeed; and
a feeding system adapted to feed deconstructed material.

19. A process controller, comprising:
a data management module configured to receive one or more measurements indicative of a controlled process of an infeed processing system;
a prediction module configured to generate estimates of a performance of the controlled process responsive to a predictive model and the one or more measurements indicative of the controlled process; and
an intelligence module configured to generate process condition adjustments responsive to an intelligence model and the one or more measurements indicative of the controlled process.

20. The process controller of claim 19, further comprising a process control module configured to generate commands configured to effectuate a change in the infeed processing system, wherein the commands are generated responsive to one or more of the estimates and the process condition adjustments.

21. The process controller of claim 19, further comprising an optimization module configured to provide one or more optimization parameters.

22. The process controller of claim 21, wherein the predictive model associates at least one of the one or more optimization parameters to one or more of a condition of the infeed processing system and a condition of infeed material.

23. The process controller of claim 22, wherein the intelligence model associates at least one of the one or more optimization parameters to at least one process condition of the infeed processing system.

24. The process controller of claim 23, further comprising a database of historical datasets the datasets comprising data indicative of historical performance of the infeed processing system, and data indicative of one or more historical operational conditions of the infeed processing system.

25. The process controller of claim 24, wherein the data management module is configured to update the historical datasets responsive to the one or more measurements.

26. A method of controlling a process, comprising:
calculating one or more performance estimates of a controlled material deconstruction process responsive to a first computer heuristic model and at least one measurement indicative of one or more electronically observed conditions of the controlled material deconstruction process;
calculating one or more process condition adjustments responsive to a second computer heuristic model, at least one upset condition, and the at least one measurement; and
generating a command responsive to the one or more process condition adjustments, the command comprising one or more parameters to effectuate a change in the controlled material deconstruction process.

27. The method of claim 26, further comprising identifying the upset condition responsive to a comparison of the at least one measurement to a pre-defined threshold.

28. The method of claim 26, further comprising presenting one or more of performance estimates and the one or more process condition adjustments to a dashboard.

29. The method of claim 28, further comprising receiving an operator command and generating the command at least in part on the received operator command.

30. The method of claim 29, further comprising updating a historical dataset responsive to the received operator command.

31. The method of claim 30, wherein updating the historical dataset further comprises updating one or more training datasets and testing datasets.
